(19) United States
(12) Patent Application Publication
(10) Pub. No.: US 2019/0391976 A1
(43) Pub. Date: Dec. 26, 2019

(54) RESEARCH AND DEVELOPMENT AUXILIARY SYSTEM USING PATENT DATABASE AND METHOD THEREOF

(71) Applicant: Cheng-Yu TSAI, Taipei City (TW)

(72) Inventors: Chen-Ling TSAI, Taipei City (TW); Cheng-Yu TSAI, Taipei City (TW)

(73) Assignee: Cheng-Yu TSAI, Taipei City (TW)

(21) Appl. No.: 16/446,637

(22) Filed: Jun. 20, 2019

(30) Foreign Application Priority Data
Jun. 22, 2018 (TW) 107121551
Jun. 22, 2018 (TW) 107121552

(51) Int. Cl. G06F 16/2458; G06Q 50/18; G06F 17/27

(52) U.S. Cl. CPC G06F 16/2465; G06F 17/2785; G06Q 50/184

(57) ABSTRACT

A research and development auxiliary system using a patent database and a method are provided. By loading patent documents meet a search condition, directly analyzing the loaded patent documents with an association rule algorithm according to at least one patent classification number or technical element message corresponding to each patent document to establish association rules each including the patent classification numbers or technical element messages, and an association rule strength; and then selecting the association rule with the weak or strong association rule strength, and combining the patent classification numbers or technical element messages thereof to output suggestions that aid in research and development, the technical effect that improving the practicality in applying the patent database to assist in research and development is achieved.

### CROSS-REFERENCE TO RELATED APPLICATIONS

The present application claims the benefit of TAIWAN Patent Applications Serial Number 107121551 and 107121552, both filed on Jun. 22, 2018, which is herein incorporated by reference.

### BACKGROUND

### 1. Technical Field

The present invention relates to a research and development (R&D) auxiliary system and a method thereof. In particular, the invention pertains to an R&D auxiliary system for establishing association rules according to patent classification numbers or technical element messages, and obtaining association rule strength corresponding to each association rule to generate suggestions that contribute to R&D and a method thereof.

### 2. Description of the Related Art

In recent years, with the popularization and vigorous development of intellectual property rights, various related applications based on the patent database have sprung up, such as patent map analysis, patent data mining and patent valuation.

In general, the traditional application of the patent database is mostly oriented towards the research direction of visualization of massive analysis, machine learning, deep learning and semantic analysis. However, for the data mining of big data, the application of information science in the patent database is mostly presented towards the high demand of enterprise mergers and smart capital, and little attention is paid to the practical application of the R&D system. On the other hand, visualization software presents the beautification and interactivity of patent data, which does not have much reference significance for R&D personnel. Furthermore, the development of intellectual property (IP) is mostly dominated and managed by personnel in the legal field, and the demand in the legal field is mostly limited to the comparison of patent searches, so that the patent analysis often fails to highlight the needs of R&D personnel in the general enterprise, thereby limiting the complete development of patent analysis, causing that the R&D personnel cannot integrate the patent analysis into the development workflow. For example, it is impossible to obtain ideas for combining different technologies from the patent analysis, or to obtain suggestions for invalid comparison inferences when encountering a patent barrier from a competitor. Thus, there is a problem of poor practicality in applying the patent database to assist in research and development.

In view of this, some manufacturers have proposed the technique for applying artificial intelligence to create a technology-function matrix to provide developers with technical gathering points and technical neglected points, thereby avoiding technical hot issues and discovering new research and development directions. However, this method requires a lot of computing power of the computer, and it is unable to present the combined possibilities and relevance of different technologies, so it is easy for the developers to get into a dead end in a single technical means, the help for developers is very limited, it is difficult to directly generate patentable technology based on the technology-function matrix, and it is difficult to directly use the technology-function matrix as the basis for the argumentation of patent invalidation. Thus, it is still unable to effectively solve the problem of poor practicality in applying the patent database to assist in research and development.

In summary, it can be seen that there is a problem in the prior art of poor practicality in applying the patent database to assist in research and development. Therefore, it is necessary to propose an improved technical solution to solve this problem.

### SUMMARY

In view of the prior art, there is a problem of poor practicality in applying the patent database to assist in research and development, and the present invention discloses an R&D auxiliary system using at least one patent database and a method thereof.

First, the R&D auxiliary system using the at least one patent database disclosed in the present invention includes the at least one patent database, a search module, an analysis module, and a processing module. The at least one patent database is configured to store a plurality of patent documents, each patent document comprising at least one patent classification number. The search module is configured to provide for inputting a search condition, and transmit the inputted search condition to the at least one patent database for patent search, and query the patent documents that meets the search condition. The analysis module is configured to load the queried patent documents, and analyze the at least one patent classification number of each loaded patent documents by an association rule algorithm, and establish a plurality of association rules according to an analysis result, each of the plurality of association rules including at least two of the patent classification numbers and an association rule strength. The processing module is configured to select the association rule with a weak association rule strength, and combine the at least two of the patent classification numbers of the association rule with the weak association rule strength to output a derivative patent suggestion; and select the association rule with a strong association rule strength, and combine the at least two of the patent classification numbers of the association rule with the strong association rule strength to output a patent invalidation inference suggestion.

In addition, the R&D support method using the at least one patent database disclosed in the present invention includes the steps of: storing a plurality of patent documents in the at least one patent database, each patent document including at least one patent classification number; providing for inputting a search condition, and transmitting the inputted search condition to the at least one patent database for patent search, and querying the patent documents that meets the search condition; loading the queried patent documents, and analyzing the patent classification numbers of the loaded patent documents by an association rule algorithm, and establishing a plurality of association rules according to an analysis result, each of the plurality of association rules including at least two of the patent classification numbers and an association rule strength; and selecting the association rule with a weak association rule strength, and combining the at least two of the patent classification numbers of the association rule with the weak association rule strength to output a derivative patent suggestion; and selecting the association rule with a strong association rule strength, and combining the at least two of the patent classification numbers of the association rule with the strong association rule strength to output a patent invalidation inference suggestion.

Then, another R&D auxiliary system using the at least one patent database disclosed in the present invention includes the at least one patent database, a search module, an analysis module, and a processing module. The at least one patent database is configured to store a plurality of patent documents. The search module is configured to provide for inputting a search condition, and transmit the inputted search condition to the at least one patent database for patent search, and query the patent documents that meets the search condition. The analysis module is configured to load the queried patent documents, and perform a natural language processing and a semantic analysis on contents of each patent document loaded, and generate at least one technical element message corresponding to each patent document according to text mining. The association module is configured to perform an association rule algorithm to analyze all the generated technical element messages, and establish a plurality of association rules according to an analysis result, wherein each association rule includes at least two of the technical element messages and an association rule strength. The processing module is configured to select the association rule with a weak association rule strength, and combine the at least two of the technical element messages of the association rule with the weak association rule strength to output a patentable R&D suggestion; and select the association rule with a strong association rule strength, and combine the at least two of the technical element messages of the association rule with the strong association rule strength to output a patent invalidation inference suggestion.

Moreover, another R&D auxiliary method using the at least one patent database disclosed in the present invention includes the steps of: storing a plurality of patent documents in the at least one patent database; providing for inputting a search condition, and transmitting the inputted search condition to the at least one patent database for patent search, and querying the patent documents that meets the search condition; loading the queried patent documents, and performing a natural language processing and a semantic analysis on contents of each patent document loaded, and generating at least one technical element message corresponding to each patent document according to text mining; performing an association rule algorithm to analyze all the generated technical element messages, and establishing a plurality of association rules according to an analysis result, wherein each association rule includes at least two of the technical element messages and an association rule strength; and selecting the association rule with a weak association rule strength, and combining the at least two of the technical element messages of the association rule with the weak association rule strength to output a patentable R&D suggestion; and selecting the association rule with a strong association rule strength, and combining the at least two of the technical element messages of the association rule with the strong association rule strength to output a patent invalidation inference suggestion.

The system and method disclosed by the present invention are as above, and the difference from the prior art is that loading patent documents meet a search condition, directly analyzing the loaded patent documents with an association rule algorithm according to at least one patent classification number or technical element message corresponding to each patent document to establish association rules each including the patent classification numbers or technical element messages, and an association rule strength; and then selecting the association rule with the weak or strong association rule strength, and combining the patent classification numbers or technical element messages thereof to output suggestions that aid in research and development.

Above-mentioned technical means can be used to solve the problems of the prior art, and to achieve the technical effect of improving the practicality in applying the patent database to assist in research and development.

### BRIEF DESCRIPTION OF THE DRAWINGS

The structure, operating principle and effects of the present invention will be described in detail by way of various embodiments which are illustrated in the accompanying drawings.

FIG. 1 is a system architecture diagram of an R&D auxiliary system using at least one patent database according to the present invention.

FIG. 2 is a flow chart of an R&D auxiliary method using at least one patent database according to the present invention.

FIG. 3 is another system architecture diagram of an R&D auxiliary system using at least one patent database according to the present invention.

FIG. 4 is another flow chart of an R&D auxiliary method using at least one patent database according to the present invention.

FIG. 5A is a schematic diagram of the generation of a derivative patent suggestion using the present invention.

FIG. 5B is a schematic diagram of the generation of a development suggestion using the present invention.

FIG. 6A is a schematic diagram of the generation of a patent invalidation inference suggestion using the present invention.

FIG. 6B is another schematic diagram of the generation of a patent invalidation inference suggestion using the present invention.

### DETAILED DESCRIPTION

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

As used herein, the term “or” includes any and all combinations of one or more of the associated listed items. It will be understood that when an element is referred to as being “on” “connected to” or “coupled to” another element, it can be directly on, connected or coupled to the other element, or intervening elements may be present. In contrast, when an element is referred to as being “directly on” “directly connected to” or “directly coupled to” another element, there are no intervening elements present.

In addition, unless explicitly described to the contrary, the word “comprise” and variations, such as “comprises” or “comprising”, will be understood to imply the inclusion of stated elements but not the exclusion of any other elements.

Before describing the R&D auxiliary system using at least one patent database and the method thereof disclosed in the present invention, the nouns defined by the present invention are described. The strength of the association rule in the present invention refers to the strength of the link between association elements (namely: “patent classification number” or “technical element message”) in the same association rule, such as a strong link or a weak link. For example, when the number of occurrences of these elements is greater than a certain preset value, the strength of the association rule is strong, or it is called a strong link.; otherwise, it means that the strength of the association rule is weak, or it is called a weak link. In the field of the messages exploration, the association rule analysis is the most commonly used method, and the method is roughly the concept of “if the previous item antecedent(s) and then the subsequent item(s)”. The purpose is to find out the correlation between the messages in the database. Technical elements such as a technical name, a technical classification or a technical field are recorded in the technical element message described in the present invention. For example, “neural network”, “image processing” or “information security” can be called a technical element, and the message describing the technical element is the technical element message. Broadly speaking, patent classification numbers can also be considered as technical elements.

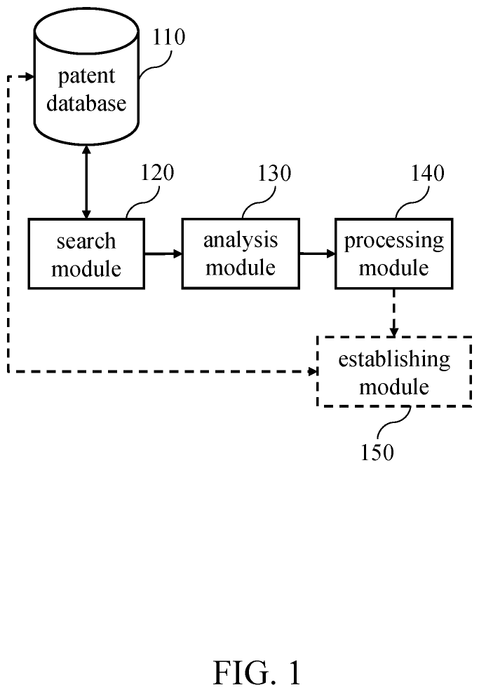

The following is a further description of the R&D auxiliary system using at least one patent database and the method thereof disclosed in the present invention with reference to the drawings. Please refer to FIG. 1, and FIG. 1 is a system architecture diagram of an R&D auxiliary system using at least one patent database according to the present invention. The R&D auxiliary system includes a patent database 110, a search module 120, an analysis module 130, and a processing module 140. The patent database 110 is used to store patent documents, and each patent document includes at least one patent classification number. In actual implementation, the patent database 110 may be a patent database set up by a patent authority of each country/region, or a patent database established by a private sector, organization or individual. If the patent database is self-established, the patent documents stored in the patent database can be purchased and updated directly to the patent authority of each country/region. In particular, the at least one patent classification number marked in each patent document is the summary technical element of the complete technical solution defined by the professional examiner of the patent authority before the approval of the patent application, that is, the combination of different technologies summarized by the profession of the examiner. Therefore, as long as the patent classification number is known, the technical field to which the patent belongs can be quickly and accurately known without the need to browse the entire patent. Take U.S. Pat. No. U.S. Pat. No. 9,038,127 as an example, its technology is information security, especially for policies and preventing unauthorized use of data (including preventing piracy, privacy violations or unauthorized data modification). Therefore, the examiner marked “726/1” and “726/26” as its patent classification numbers, which are used to correspond with its technologies. Therefore, each patent classification number can be regarded as a single technical element. When the patent document has multiple patent classification numbers at the same time, it can be considered that the patent is composed of a plurality of technical elements.

The search module 120 is configured to provide for inputting a search condition, and transfer the inputted search condition to the patent database 110 for patent search to query a patent documents that meet the search condition. In actual implementation, the search condition input by the user may include keywords (such as word, patent classification number, and patent number), logical operators (such as “AND”, “OR”, and “NOT”) and specified search fields (such as “@TI”, and “/TTL”). For example, the search condition may be “Internet of Things AND A63F 13/32”, “(network)@TI”, “TTL/network”, and the like. In particular, different patent databases 110 may use different methods to specify search fields. For example, “@” or “/” is used to specify the search field. Take the Chinese patent database as an example, the search condition is “(network)@TI”, which means that the specified search field of the keyword “network” is set as the title. Take the English patent database as an example, the search condition is “TTL/network”, which represents that the specified search field of the keyword “network” is set as the title. In addition, the patent classification number may include a US Patent Classification (UPC), an International Patent Classification (IPC), a Cooperative Patent Classification (CPC), and a Japanese FI-F-Term and so on, and can have a hierarchy of classes and subclasses.

The analysis module 130 is configured to load the queried patent documents, and analyze the patent classification numbers of the loaded patent documents by using an association rule algorithm, and establish association rules according to the analysis result, and each association rule includes at least two patent classification numbers and an association rule strength. In practical implementation, the association rule algorithm may be an Apriori algorithm for data mining simultaneously combined with the multi-dimensional analysis or time series analysis, and is used to analyze the patent classification numbers of the loaded patent documents. Specifically, the Apriori algorithm is the most representative algorithm for mining the Boolean value association rules of frequent itemsets. The subsequently developed association rule algorithms are mostly based on the Apriori algorithm. The main concept is to use an itemset (such as a patent classification number) to establish association rules in a large number of data sets (such as patent documents), and calculate the number of occurrences of each candidate item, and according to the set minimum support as the threshold, it is used to measure whether the association rule of the candidate item is significant. For example, suppose there are four patent documents, and each patent document includes patent classification numbers with the following letters:

Patent Document 1, which includes patent classification numbers A, C, and D.

Patent Document 2, which includes patent classification numbers B, C, and E.

Patent Document 3, which includes patent classification numbers A, B, C, and E.

Patent Document 4, which includes patent classification numbers B and E.

When the association rules are established using the Apriori algorithm, the search and deletion of the set of high frequency itemsets are performed, and the steps are as follows:

(1) Converting data into discrete data represented by code or Boolean value, and establishing the set of 1-itemset from the single patent classification number combination at the grassroots level in the way of progressive search, and after the first scan, obtaining C1 and calculating the support corresponding to each itemset (in this case, 1-itemset: {A} to {E}, the corresponding support is: 0.5, 0.75, 0.75, 0.25, 0.75). Next, comparing the obtained support with the specified support threshold S to determine the high-frequency itemsets. If the support threshold S is 0.5, then the itemset {D} is excluded because its support is only 0.25, so the high frequency 1-itemset {A}, {B}, {C}, and {E} are obtained, and recorded as L1.

(2) Combining the high frequency 1-itemset into six 2-itemset and recorded as C2; then, calculating the support as well (for example, 2-itemset: {A, B}, {A, C}, {A, E}, {B, C}, {B, E}, {C, E}, the corresponding support is: 0.25, 0.5, 0.25, 0.5, 0.75, 0.5), then, determining the high-frequency itemsets according to the support threshold S, wherein the itemsets {A, B} and {A, E} with the support of 0.25 are excluded, and the high-frequency 2-itemset {A, C}, {B, C}, {B, E}, {C, E} are obtained, and recorded as L2.

(3) Continuing progressive search to confirm whether the itemset containing the three items also meets the characteristics of the high-frequency itemsets. Since each itemset in L2 is in the progressive search, only one 3-itemset can be found, i.e., {B, C, E}, and be recorded as C3. Here, because the sub-itemset {A, E} in the itemset {A, C, E} is not a high-frequency itemset, and it is not necessary to list the itemset {A, C, E} in C3; and the sub-itemsets {B, C}, {B, E}, {C, E} of the itemset {B, C, E} are all high-frequency itemsets, so the itemset {B, C, E} also has the opportunity to become a high frequency itemset. Next, after the support is calculated to be 0.5, not lower than the support threshold S, the high-frequency 3-itemset {B, C, E} is obtained and recorded as L3.

(4) Next, using the found high frequency 3-itemset {B, C, E} to establish association rules, in this example, 12 possible association rules can be established, and calculating the support and lift corresponding to these rules in order. The support and lift are as shown in the following table:

| Rule | Support | Lift |
|---|---|---|
| If B then C | 0.5 | 0.889 |
| If B then E | 0.75 | 1.333 |
| If C then B | 0.5 | 0.889 |
| If C then E | 0.5 | 0.889 |
| If E then B | 0.75 | 1.333 |
| If E then C | 0.5 | 0.889 |
| If B then C and E | 0.5 | 1.333 |
| If C then B and E | 0.5 | 0.889 |
| If E then B and C | 0.5 | 1.333 |
| If B then C and E | 0.5 | 1.333 |
| If B then E and C | 0.5 | 0.889 |
| If C then E and B | 0.5 | 1.333 |

Wherein, the support represents the probability that the preceding item (X) and the latter item (Y) appear at the same time, and the mathematical expression is:

$${S}_{X \to Y} = \frac{\vert T ( X ⋂ Y ) \vert}{\vert T \vert} ,$$

|T| represents all data sets; the lift is the ratio of the confidence and the support of the latter term, the lift greater than 1 means that the appearance of X promotes the appearance of Y, and its mathematical expression is expressed as:

$${L}_{x \to y} = \frac{{C}_{X \to Y}}{{S}_{Y}} = \frac{\vert T ( X ⋂ Y ) \vert}{\vert T ( X ) \vert} / \frac{\vert T ( Y ) \vert}{\vert T \vert} .$$

Next, according to at least one of the support and the lift, at least one significant association rule can be found out (for example, the support is greater than 0.5 or the lift is greater than 1), and the associated rule strength of the significant association rule is set to strong (or called as a strong link), and set the associated rule strength of the non-significant association rule to weak (or called as a weak link). In other words, the association rule strength may be generated according to the number of the patent documents inquired, the number of patent documents in which the patent classification numbers included in the corresponding association rule, and the like. Assuming that the number of patent documents is 1024, and the patent classification numbers included in the association rule are “705” and “2”, the association rule strength can be calculated based on how many patent documents have the patent classification numbers “705” and “2” at the same time in the 1024 patent documents. The greater the number of patent documents is, the stronger the association rule strength is; the less the number of patent documents is, the weaker the association rule strength is. That is, the number of patent classification numbers appearing in the same patent document at the same time is positively correlated with the association rule strength.

It should be added that when implementing the Apriori algorithm, the association of technical elements is not divided into the former term and the latter item of the general market basket analysis. The associated items are the means to achieve the program, and there is no succession. Unless it is clearly defined that the technical elements familiar to the R&D personnel are the former, to glimpse which technical element to associate with the latter term (the higher the lift is, the better the association rule is, because it means that the emergence of the former item has a positive effect on the emergence of the latter item). Thus, in the above example, “If B then C” and “If C then B” can be regarded as the same association rule; “If B then E” and “If E then B” can be regarded as the same association rule; and “If C then E” and “If E then C” can be regarded as the same association rule, and a total of nine possible association rules are obtained. In addition, if the evidence of invalid inference for a patent is wanted to be found, an association rule with a strong association rule strength should be chosen. Conversely, if the innovation elements of a certain technology are wanted to be collected, the visualization of the association rules of outliers (or association rules for grouping) becomes very meaningful. Because in the case that huge patent data cannot be manually reviewed, combinable cross-industry elements can be intuitively explored, which is an analysis method that was not adopted in the previous market basket analysis. Because in the traditional association rule analysis, these association rules are excluded as noise.

The processing module 140 is configured to combine the patent classification numbers of the association rule with a weak association rule strength to output the derivative patent suggestion. For example, if the patent classification numbers include “E03D” and “H05K” in the association rule with the weak association rule strength, then the combination of the two patent classification numbers can be used as the derivative patent suggestion. In other words, the derivative patent suggestion may suggest that the developer consider the relevant technology or further improved technical means based on the combination of the technologies represented by the patent classification numbers “E03D” and “H05K”. This method is easy to guide the developers to think of patentable technical means. Because the weak association rules strength represents that there are fewer patent documents that combine these two technologies, the technical idea on this basis is less likely to be duplicated with the prior art. On the other hand, when the examiner conducts the patent examination, it is not easy to find the prior art that can be used to disapprove the application, so it can effectively increase the probability of patent approval. In actual implementation, the derivative patent suggestion may be embedded in a patent document that matches the combined patent classification numbers, for example, copying patent documents and merging them into the derivative patent suggestion, or embedding the number, name and storage path of the patent document into the derivative patent suggestion by hyperlink.

In addition, in actual implementation, the system of the present invention may further include an establishing module 150 for using the patent classification numbers of each association rule as a search condition, so as to download the patent documents that meet the search condition from the patent database 110, and sort and store these patent documents according to different patent classification numbers of each association rule to form a technical element library. In other words, the technology corresponding to each patent classification number can be regarded as a technical element, and the technical element library comprises a plurality of technical elements, and each technical element has a corresponding patent document. In practical implementation, the technical element library stores the prior patent documents to which each technology belongs in a fixed folder, for example, using the patent classification number as the folder name. In this way, under the premise of referring to similar technical elements, different technical means and different application scenarios of all application elements can be directly searched in different defined folders without repeatedly searching from the patent database 110 or wasting other research work.

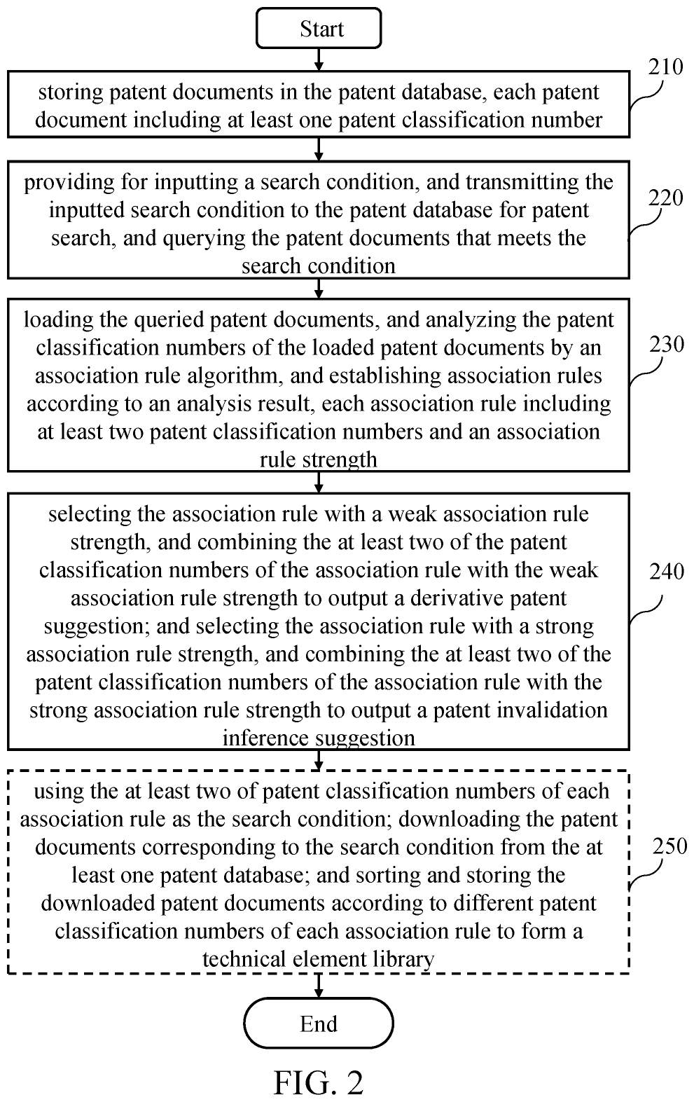

Next, please refer to FIG. 2, FIG. 2 is a flow chart of an R&D auxiliary method using at least one patent database according to the present invention. The R&D auxiliary method comprises the steps of: storing patent documents in the patent database 110, each patent document including at least one patent classification number (step 210); providing for inputting a search condition, and transmitting the inputted search condition to the patent database 110 for patent search, and querying the patent documents that meets the search condition (step 220); loading the queried patent documents, and analyzing the patent classification numbers of the loaded patent documents by an association rule algorithm, and establishing association rules according to an analysis result, each association rule including at least two patent classification numbers and an association rule strength (step 230); and selecting the association rule with a weak association rule strength, and combining the at least two of the patent classification numbers of the association rule with the weak association rule strength to output a derivative patent suggestion; and selecting the association rule with a strong association rule strength, and combining the at least two of the patent classification numbers of the association rule with the strong association rule strength to output a patent invalidation inference suggestion (step 240). Through the above steps, the patent documents that meet the search condition are downloaded, the patent documents can be directly analyzed according to the patent classification numbers and the association rule algorithm, and the association rules including the patent classification numbers and the association rule strength can be established. The patent classification numbers of the association rule with the weak/strong association rule strength are combined to output a derivative patent suggestion/a patent invalidation inference suggestion.

In addition, after step 240, the patent classification numbers of each association rule may also be used as a search condition, and the patent documents meeting the search condition are downloaded from the patent database 110, and the downloaded patent documents are sorted and stored to form a technical element library according to different patent classification numbers of each association rule (step 250).

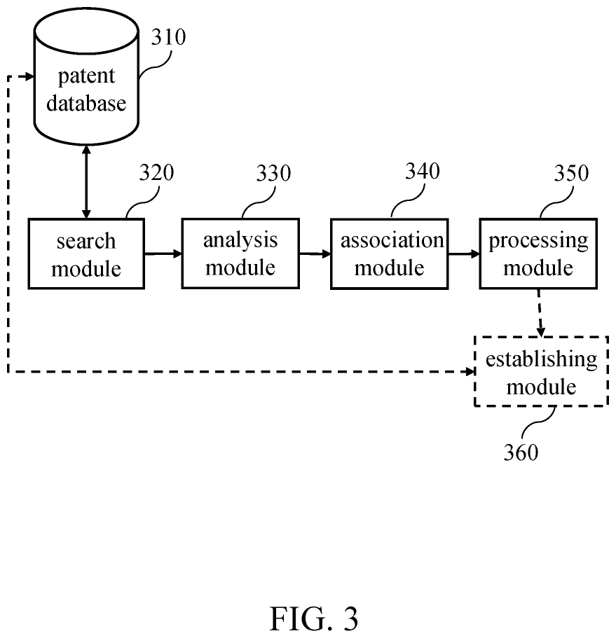

Next, please refer to FIG. 3, FIG. 3 is another system architecture diagram of an R&D auxiliary system using at least one patent database according to the present invention. The system comprises: a patent database 310, a search module 320, an analysis module 330, an association module 340 and a processing module 350. The patent database 310 and the search module 320 are identical to the patent database 110 and the search module 120 of FIG. 1 and therefore will not be repeated here.

The analysis module 330 is configured to load the inquired patent documents, and perform natural language processing and semantic analysis on the contents of each of the loaded patent documents, and generate at least one technical element message corresponding to each patent document according to text mining. In actual implementation, in the process of generating the technical element message corresponding to each patent document, auxiliary queries can be made through a proper noun database or a patent classification database to extract technical field or patent classification description of the proper noun corresponding to the technical element message as a technical element message. For example, after performing natural language processing and semantic analysis on the content of a patent document, it can be known that the vocabulary in the content belongs to a subject, an adverb, a noun, an adjective or a preposition, and the like, and then, the part of the noun can be directly used as a technical element message, and it can even be used with a proper noun database or a patent classification database for auxiliary queries, so as to screen out technical terms, and retain technical terms (i.e., proper nouns) and obtain the technical field to which they belong; or the data in the proper noun database or the patent classification database are used as a comparison sample of the text mining to generate the technical element message; or a patent classification description containing the noun is found in the patent classification database, and the patent classification description may include the patent classification number and its description. At this point, the above-mentioned proper nouns and their technical fields, even the patent classification number and its description, can be used as the technical element messages corresponding to the patent document. For example, the technical element messages can be recorded as “proper noun: neural network; technical field: network” or “proper noun: neural network; technical field: network; patent classification number and its description: neural network for image processing G06T, neural network for analyzing speech or audio G10L 25/30.”

The association module 340 is configured to execute an association rule algorithm to analyze all generated technical element messages, and establish a plurality of association rules according to the analysis result, wherein each association rule includes at least two technical element messages and an association rule strength. The difference between the association module 340 and the analysis module 130 of FIG. 1 is that the association module 340 generates association rules based on the technical element messages generated by the analysis module 330, and the analysis module 130 of FIG. 1 generates association rules based on the patent classification numbers. That is to say, the association module 340 analyzes the technical element messages corresponding to the loaded patent documents by using the association rule algorithm, and then generates association rules each including the technical element messages and the association rule strength; and the analysis module 130 of FIG. 1 analyzes the patent classification numbers of the loaded patent documents by the association rule algorithm, and then generates association rules each including the patent classification numbers and the association rule strength.

The processing module 350 is configured to select an association rule with a weak association rule strength, and combine the technical element messages to output the patentable R&D suggestion; and select an association rule with a strong association rule strength, and combine the technical element messages to output the patent invalidation inference suggestion. For example, if the technical element messages contained in the association rule with the weak association rule strength are “neural network” and “geometric attribute analysis”, then the combination of these two technical element messages can be used as a R&D suggestion. In other words, the R&D suggestion can make the developers consider relevant technologies or further improved technical means based on the combination of technologies represented by “neural network” and “geometric attribute analysis”. This method is easy to guide the developers to think of patentable technology. Because the weak association rules strength represents that there are fewer patent documents combining these two technologies, the technical idea on this basis is less likely to be duplicated with the prior art. On the other hand, when the examiner conducts the patent examination, it is not easy to find the prior art that can be used to disapprove the application, so it can effectively increase the probability of patent approval. In practical implementation, the R&D suggestion may be embedded in a patent document that matches the combined technical element messages, for example, copying patent documents and merging them into the R&D suggestion, or embedding the number, name and storage path of the patent document into the R&D suggestion by hyperlink. Next, suppose that technical element messages included in the association rule with the strong association rule strength are “neural network” and “deep learning”, then the combination of the two technical element messages can be a patent invalidation inference suggestion. Because the strong association rule strength represents that there are a large number of patent documents simultaneously containing the two technical element messages, it is easy to find the prior art, which is conducive to the dialectical support in the evidence and discussion for subsequent invalidating the patent at dispute, thereby increasing the probability of revoking the patent right of the patent at dispute. A method for generating patent invalidation inference suggestions will be described in detail later in conjunction with the drawings.

It should be added that, the system disclosed in FIG. 3 can comprise the establishing module 360. The establishing module 360 is the same as the establishing module 150 of FIG. 1, and the patent documents are classified and stored the loaded patent documents according to the patent classification numbers of the loaded patent documents to form a technical element library.

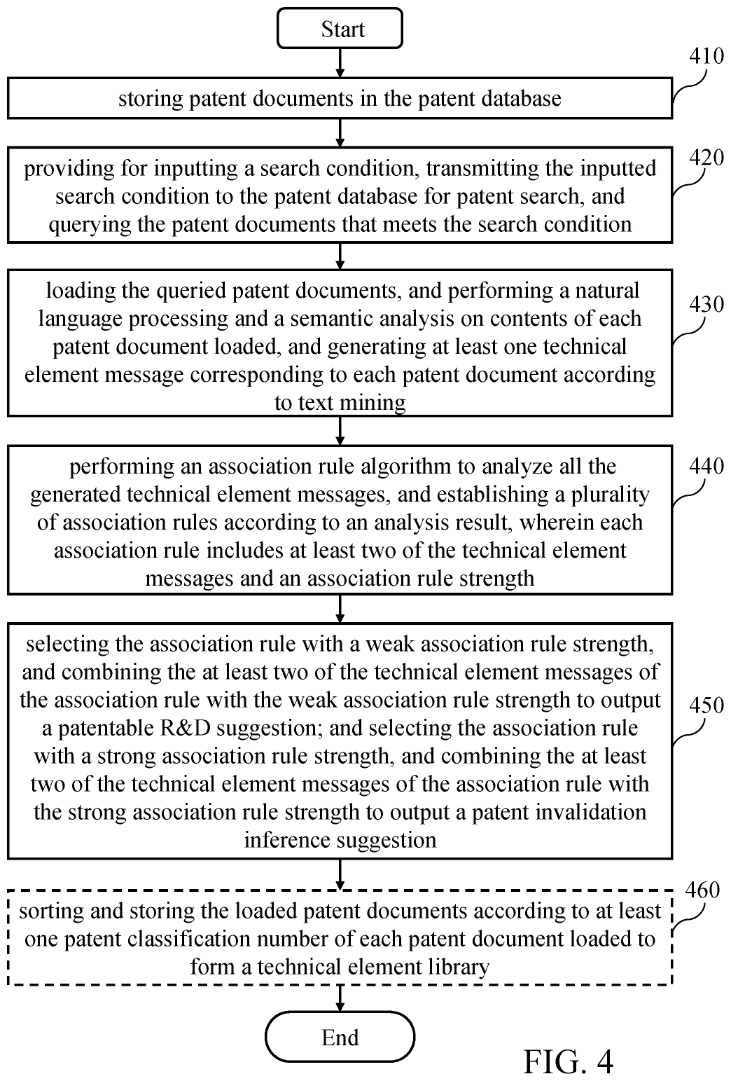

Next, please refer to FIG. 4, FIG. 4 is another flow chart of an R&D auxiliary method using at least one patent database according to the present invention. The R&D auxiliary method comprises the steps of: storing patent documents in the patent database 310 (step 410); providing for inputting a search condition, transmitting the inputted search condition to the patent database 310 for patent search, and querying the patent documents that meets the search condition (step 420); loading the queried patent documents, and performing a natural language processing and a semantic analysis on contents of each patent document loaded, and generating at least one technical element message corresponding to each patent document according to text mining (step 430); performing an association rule algorithm to analyze all the generated technical element messages, and establishing a plurality of association rules according to an analysis result, wherein each association rule includes at least two of the technical element messages and an association rule strength (step 440); and selecting the association rule with a weak association rule strength, and combining the at least two of the technical element messages of the association rule with the weak association rule strength to output a patentable R&D suggestion; and selecting the association rule with a strong association rule strength, and combining the at least two of the technical element messages of the association rule with the strong association rule strength to output a patent invalidation inference suggestion (step 450). The above steps are similar to the steps shown in FIG. 2. The main difference is that the steps of FIG. 2 are to directly use the patent classification numbers in the patent documents for association processing, and the steps of FIG. 4 are to use the technical element messages generated in step 430 for association processing. Steps 410 and 420 are similar to steps 210 and 220 of FIG. 2; steps 440 and 450 are similar to steps 230 and 240 of FIG. 2, and the difference is only that steps 440 and 450 are for processing technical element messages, while steps 230 and 240 are for processing patent classification numbers. In particular, after step 450, may also be sorting and storing the loaded patent documents according to at least one patent classification number of each patent document loaded to form a technical element library (step 460).

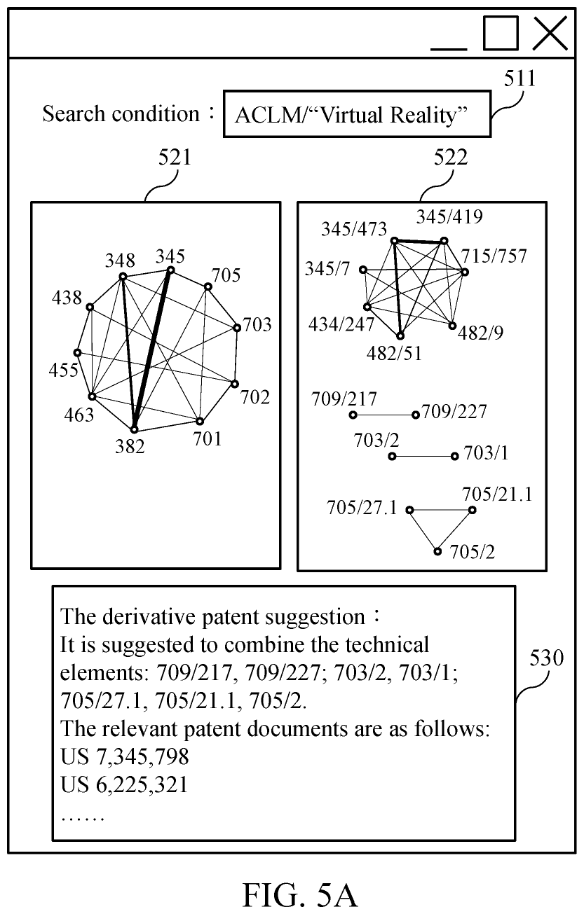

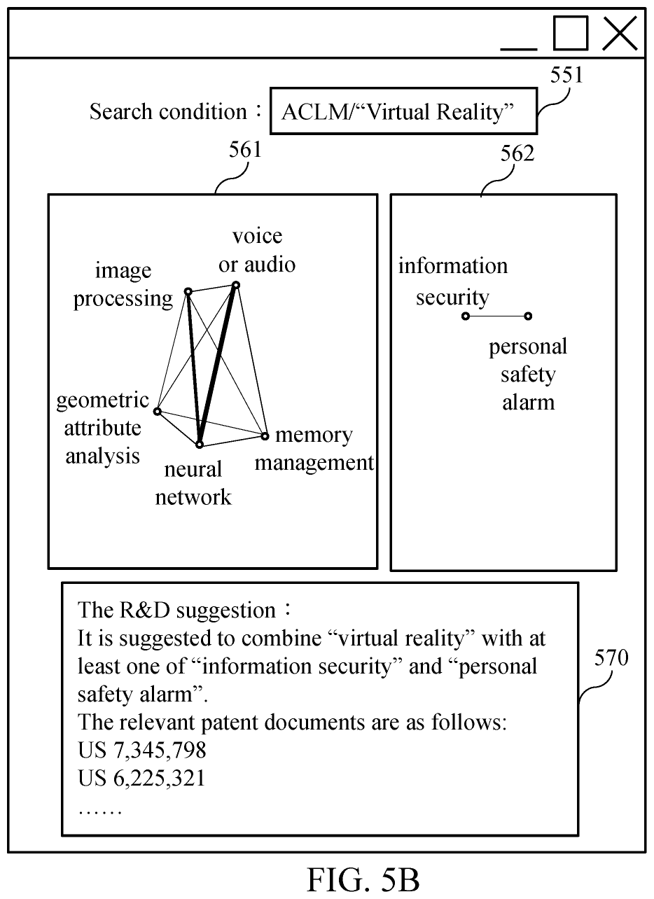

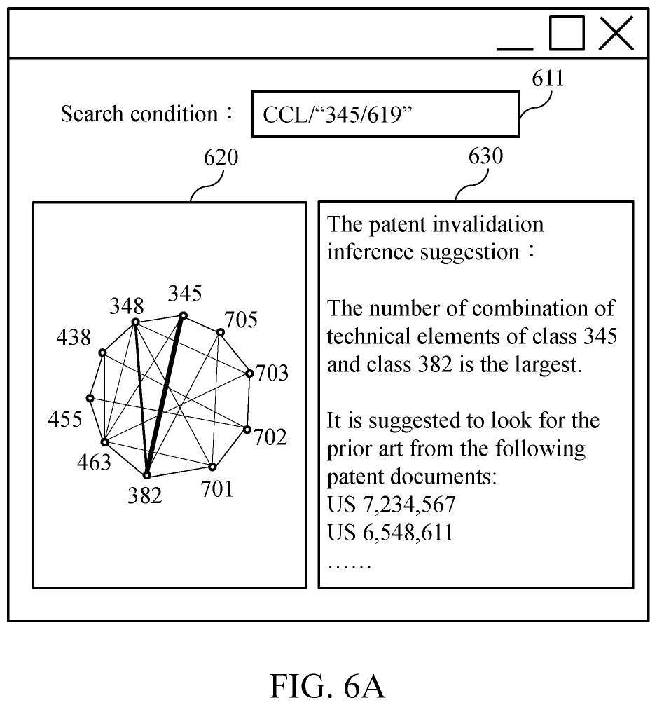

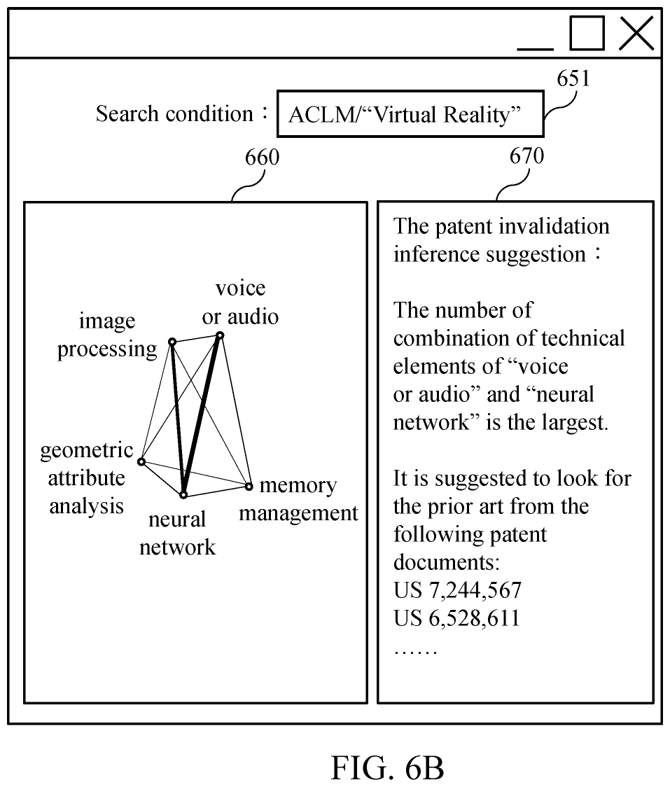

The following description will be made by way of example with reference to FIG. 5A to FIG. 6B. Please refer to FIG. 5A first, and FIG. 5A is a schematic diagram of the generation of a derivative patent suggestion using the present invention. Assume that the developer has a technical background of Virtual Reality (VR) or Augmented Reality (AR), and wants to make innovations based on this technology. The developer can input a search condition in the input block 511, such as ACLM/“Virtual Reality” or ACLM/“Augmented Reality”. At this time, the search module 120 transmits the search condition input by the developer to the patent database 110 for patent search, and queries the corresponding patent documents. Next, the analysis module 130 loads the queried patent documents from the patent database 110, and uses the association rule algorithm, such as the Apriori algorithm, to perform association analysis on the patent classification numbers of these patent documents. In practical implementation, since the patent classification number is multi-level data, it can be used for macro or micro association analysis only by the single level, such as the class, or the multiple levels, such as the class and the subclass, at the same time. Taking the class as an example, after using the association rule algorithm to perform analysis, association rules corresponding thereto may be generated, and the association rules may be graphically presented in the first display block 521, wherein the two ends of the line are the associated patent classification numbers in the association rule (in this case, the classes are used), and the thick or thin of the line represents the association rule strength is strong or weak. For example, the thick line represents a high degree of association, that is, the association rule strength corresponding to the classes at both ends of the thick line is strong, and it is also represented that the two classes are the combination of technical elements that are often used. In addition, aside from the above-mentioned analysis using the classes, in actual implementation, the analysis is performed using the classes and subclasses simultaneously in the same manner to generate the association rules corresponding thereto, and the association rules are also presented in the second display block 522 in a graphical manner. It is worth mentioning that many association rules for grouping appear in the second display block 522, for example, “709/227, 709/217”, “705/26.1, 705/27.1, 705/2”, “703/2, 703/1”. The association rules for grouping can be regarded as “groups of association rules of innovation elements”. That is to say, the patent classification numbers in these association rules, the technologies which represents are very suitable as the technical elements to be combined (for example, technical elements suitable for different industries). Finally, the processing module 140 combines the patent classification numbers in the association rule whose association rule strength is weak to output a derivative patent suggestion, and the output mode can be to create a file or directly displayed in suggestion block 530. At this point, the developer can view the derivative patent suggestions displayed in the suggested block 530, for example, how to combine multi-computer transmissions of virtual reality, computer and digital processing systems, especially remote data access (US Patent Classification: 709/217) and computer-to-computer session/connection establishment (US Patent Classification: 709/227) and other techniques to produce a patentable technology. In the process of the developer's thought, the developer can also select the displayed patent number in the suggestion block 530 to open the corresponding patent document for browsing. It should be added that when there are too many technical elements (patent classification numbers or called as items) involved, it is also attempted to list the different sections according to the time sequence (technical development process) when the patent documents issued. The latest announcements (i.e.: the first section) to the earliest announcements (i.e.: nth section) are split for analysis and graphical presentation, for example, the first section (1˜100 technical elements), the second section (101˜200 technical elements), the third section (201˜300 technical elements), and so on to the nth section. In this way, the development and application of technical elements in different time intervals (such as a development period, a maturity period and a recession period) can be snooped.

As shown in FIG. 5B, FIG. 5B is a schematic diagram of the generation of a development suggestion using the present invention. Similarly, assume that the developer has a technical background of VR or AR, and wants to make innovations based on this technology. The developer can input a search condition in the input block 551, such as ACLM/“Virtual Reality” or ACLM/“Augmented Reality”. At this time, the search module 320 transmits the search condition input by the developer to the patent database 310 for patent search, and queries the corresponding patent documents. Next, the analysis module 330 loads the patent documents that are inquired, and performs the natural language processing and semantic analysis on the contents of each of the loaded patent documents, and generates technical element messages corresponding to each patent document according to the text mining. The association module 340 performs the association rule algorithm, such as the Apriori algorithm, for association analysis of the technical element messages of the patent documents, and generates the association rules corresponding thereto according to the analysis result, and the association rules can be graphically presented in the first display block 561, wherein the two ends of the line are the associated technical element messages in the association rule, and the thick or thin of the line represents the association rule strength is strong or weak. For example, the thick line represents a high degree of association, that is, the association rule strength corresponding to the technical element messages at both ends of the thick line is strong, and it is also represented that the two technical element messages are the combination of technical elements that are often used. In addition, if there are association rules for grouping (i.e., association rules belonging to different groups with the technical element messages in the first display block 561), for example, “information security and personal safety alarm” is displayed independently in the second display block 562 as shown in FIG. 5B. The association rules for grouping can be regarded as “groups of association rules of innovation elements”. That is to say, the technical element messages in these association rules, the technologies which represents are very suitable as the technical elements to be combined (for example, technical elements suitable for different industries). Finally, the processing module 350 combines the technical element messages in the association rule with the weak association rule strength to output a R&D suggestion, and the output mode can be to create a file or directly displayed in suggestion block 570. At this point, the developer can view the R&D suggestions displayed in the suggested block 570, and think how to combine technologies such as virtual reality, information security, and personal safety alarm to develop a patentable technology. In the process of the developer's thought, the developer may also select the displayed patent number in the suggestion block 570 to open the patent document related to the above technology for browsing. It should be added that when there are too many technical elements involved (such as proper nouns, technical fields, and patent classification numbers; or called as items), it is also attempted to list the different sections according to the time sequence (technical development process) when the patent documents issued. The latest announcements (i.e.: the first section) to the earliest announcements (i.e.: nth section) are split for analysis and graphical presentation, for example, the first section (1˜100 technical elements), the second section (101˜200 technical elements), the third section (201˜300 technical elements), and so on to the nth section. In this way, the development and application of technical elements in different time intervals (such as a development period, a maturity period and a recession period) can be snooped.

As shown in FIG. 6A, FIG. 6A is a schematic diagram of the generation of a patent invalidation inference suggestion using the present invention. Assume that the developer encounters a patent infringement litigation or receives a warning letter, the patent classification number of the patent at dispute can be directly input to the input block 611 as a search condition. At this time, the search module 120 transmits the search condition input by the developer to the patent database 110 for patent search and queries the patent documents corresponding to the search condition. Next, the analysis module 130 loads the patent documents that are queried, and uses the association rule algorithm, such as the Apriori algorithm, to perform association analysis on the patent classification numbers of the patent documents loaded, and generate the association rules according to the analysis result. The association rules are graphically presented in display block 620, wherein the two ends of the line are the associated patent classification numbers in the association rule, and the thick or thin of the line represents the association rule strength is strong or weak. For example, a thick line represents a high degree of association (i.e., the association rule strength is strong), and conversely represents a low degree association (i.e., the association rule strength is weak). The above process is similar to the process of FIG. 5A, the only difference is whether to analyze using the classes and the subclasses at the same time. In the FIG. 6A, only the classes are analyzed for the sake of simplicity. Next, the processing module 140 combines the patent classification numbers included in the association rule with the strong association rule strength to output the patent invalidation inference suggestion, and the output mode can be to create a file or directly displayed in suggestion block 630. At this point, the developer can browse the patent invalidation inference suggestions displayed in the suggestion block 630 to learn more about the combinations of the technical elements directly related to the patent and the patent documents corresponding to the combinations of the technical elements. For example, assume that the patent classification number of the patent at dispute is 345/619, which means that the technical field of the patent is the graphic operation in the computer graphics processing and the selective visual display system. It can be known from the patent invalidation inference suggestion that the number combined with image analysis technology (class 382) is the largest, so it can be inferred that the combination of technical elements directly related to the patent at dispute is image analysis technology. Therefore, when looking for the prior art, the image analysis technology can be used as the basis for limiting the search range, and the highly relevant prior patent documents are accurately found to serve as the dialectical support in the evidence and discussion for invalidating the patent at dispute. In other words, a derivative patent suggestion is displayed in the suggested block 530 shown in FIG. 5A, and a patent invalidation inference suggestion is displayed in the suggestion block 630 shown in FIG. 6A. The association rule with the strong association rule strength represents that the number of patent documents with patent classification numbers included in the association rule is also greater, so it is easy to find the prior art, which is conducive to the dialectical support in the evidence and discussion for subsequent invalidating the patent at dispute, thereby increasing the probability of revoking the patent right of the patent at dispute. In actual implementation, after the search condition is input, the derivative patent suggestion shown in FIG. 5A and the patent invalidation inference suggestion shown in FIG. 6A may also be displayed in the same window (not shown in the figure).

As shown in FIG. 6B, FIG. 6B is another schematic diagram of the generation of a patent invalidation inference suggestion using the present invention. Suppose that the developer encounters a patent infringement lawsuit or receives a warning letter, the developer can first review the patent at dispute and the claims thereof to determine the technical field, such as “Virtual Reality”, and then specify the field to be searched and the technical field of the patent at dispute is used as a key to generate the search condition (e.g., ACLM/“Virtual Reality”, wherein “ACLM/” is the designated claim field; “Virtual Reality” is the technical field of the patent at dispute). After the search condition is input in the input block 651, the search module 320 transmits the search condition input by the developer to the patent database 310 for patent search, and queries the patent documents corresponding to the search condition. Next, the analysis module 330 loads the patent documents corresponding to the search condition, and performs the natural language processing and semantic analysis on the contents of each of the loaded patent documents, and generates the technical element messages corresponding to each patent document according to the text mining. Next, the association module 340 executes an association rule algorithm, such as the Apriori algorithm, to perform association analysis on the technical element messages of the patent documents, and generates the association rules according to the analysis result. The association rules are graphically presented in display block 660, wherein the two ends of the line are the associated technical element messages in the association rule, and the thick or thin of the line represents the association rule strength is strong or weak. For example, a thick line represents a high degree of association (i.e., the association rule strength is strong), and conversely represents a low degree association (i.e., the association rule strength is weak). The above process is similar to the process of FIG. 5B. However, the difference is that the processing module 350 combines the technical element messages contained in the association rule with strong association rule strength to output the patent invalidation inference suggestion, and the output mode can be to create a file or directly displayed in suggestion block 670. At this point, the developer can browse the patent invalidation inference suggestion displayed in the suggestion block 670, thereby knowing that in the technical field to which the patent at dispute belongs, which technical elements are combined with the largest number of patent documents. In this example, it is apparent from the display block 660 that the number of “voice or audio” combined with “neural network” is the largest (because the connected line is the thickest), so it can be inferred that in the search for the prior art, it is easier to find a suitable prior art or a combination thereof from the patent documents containing the two technical elements, as the dialectical support in the evidence and discussion for invalidating the patent at dispute. In other words, the patentable R&D suggestion is displayed in the suggestion block 570 shown in FIG. 5B, and the patent invalidation inference suggestion is displayed in the suggestion block 670 shown in FIG. 6B. The association rule with the strong association rule strength represents that the number of patent documents with technical element messages included in the association rule is also greater, so it is easy to find the prior art, which is conducive to the dialectical support in the evidence and discussion for subsequent invalidating the patent at dispute, thereby increasing the probability of revoking the patent right of the patent at dispute. In actual implementation, after the search condition is input, the R&D suggestion shown in FIG. 5B and the patent invalidation inference suggestion shown in FIG. 6B may also be displayed in the same window (not shown in the figure).

In summary, it can be seen that the difference between the present invention and the prior art is that loading patent documents meet a search condition, directly analyzing the loaded patent documents with an association rule algorithm according to at least one patent classification number or technical element message corresponding to each patent document to establish association rules each including the patent classification numbers or technical element messages, and an association rule strength; and then selecting the association rule with the weak or strong association rule strength, and combining the patent classification numbers or technical element messages thereof to output suggestions that aid in research and development. Above-mentioned technical means can be used to solve the problem of the prior art, thereby achieving technical effect that improving the practicality in applying the patent database to assist in research and development.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A research and development (R&D) auxiliary system using at least one patent database, the system comprising:
the at least one patent database, configured to store a plurality of patent documents, each patent document comprising at least one patent classification number;
a search module, configured to provide for inputting a search condition, and transmit the inputted search condition to the at least one patent database for patent search, and query the patent documents that meets the search condition;
an analysis module, configured to load the queried patent documents, and analyze the at least one patent classification number of each loaded patent documents by an association rule algorithm, and establish a plurality of association rules according to an analysis result, each of the plurality of association rules including at least two of the patent classification numbers and an association rule strength; and
a processing module, configured to select the association rule with a weak association rule strength, and combine the at least two of the patent classification numbers of the association rule with the weak association rule strength to output a derivative patent suggestion; and select the association rule with a strong association rule strength, and combine the at least two of the patent classification numbers of the association rule with the strong association rule strength to output a patent invalidation inference suggestion.

2. The R&D auxiliary system according to claim 1, wherein the association rule algorithm is an Apriori algorithm for data mining combined with a multi-dimensional analysis or a time series analysis, and the association rule algorithm is used to analyze the patent classification numbers of the loaded patent documents.

3. The R&D auxiliary system according to claim 1, wherein the association rule strength of each association rule is adjusted according to a number of times that the at least two patent classification numbers included in each association rule simultaneously appears in the patent documents loaded, wherein the number of times is positively correlated with the association rule strength.

4. The R&D auxiliary system according to claim 1, wherein the R&D auxiliary system further includes an establishing module, configured to use the at least two patent classification numbers of each association rule as the search condition, and download the patent documents corresponding to the search condition from the at least one patent database, and sort and store the downloaded patent documents according to different patent classification numbers of each association rule to form a technical element library.

5. An R&D auxiliary method using at least one patent database, comprising following steps:
storing a plurality of patent documents in the at least one patent database, each patent document including at least one patent classification number;
providing for inputting a search condition, and transmitting the inputted search condition to the at least one patent database for patent search, and querying the patent documents that meets the search condition;
loading the queried patent documents, and analyzing the patent classification numbers of the loaded patent documents by an association rule algorithm, and establishing a plurality of association rules according to an analysis result, each of the plurality of association rules including at least two of the patent classification numbers and an association rule strength; and
selecting the association rule with a weak association rule strength, and combining the at least two of the patent classification numbers of the association rule with the weak association rule strength to output a derivative patent suggestion; and selecting the association rule with a strong association rule strength, and combining the at least two of the patent classification numbers of the association rule with the strong association rule strength to output a patent invalidation inference suggestion.

6. The R&D auxiliary method according to claim 5, wherein the R&D auxiliary method further comprises the steps of: using the at least two of patent classification numbers of each association rule as the search condition; downloading the patent documents corresponding to the search condition from the at least one patent database; and sorting and storing the downloaded patent documents according to different patent classification numbers of each association rule to form a technical element library.

7. An R&D auxiliary system using at least one patent database, the system comprising:
the at least one patent database, configured to store a plurality of patent documents;
a search module, configured to provide for inputting a search condition, and transmit the inputted search condition to the at least one patent database for patent search, and query the patent documents that meets the search condition;
an analysis module, configured to load the queried patent documents, and perform a natural language processing and a semantic analysis on contents of each patent document loaded, and generate at least one technical element message corresponding to each patent document according to text mining;
an association module, configured to perform an association rule algorithm to analyze all the generated technical element messages, and establish a plurality of association rules according to an analysis result, wherein each association rule includes at least two of the technical element messages and an association rule strength; and
a processing module, configured to select the association rule with a weak association rule strength, and combine the at least two of the technical element messages of the association rule with the weak association rule strength to output a patentable R&D suggestion; and select the association rule with a strong association rule strength, and combine the at least two of the technical element messages of the association rule with the strong association rule strength to output a patent invalidation inference suggestion.

8. The R&D auxiliary system according to claim 7, wherein the R&D auxiliary system further includes an establishing module, configured to sort and store the loaded patent documents according to at least one patent classification number of each patent document loaded to form a technical element library.

9. An R&D auxiliary method using at least one patent database, comprising following steps:
storing a plurality of patent documents in the at least one patent database;
providing for inputting a search condition, and transmitting the inputted search condition to the at least one patent database for patent search, and querying the patent documents that meets the search condition;
loading the queried patent documents, and performing a natural language processing and a semantic analysis on contents of each patent document loaded, and generating at least one technical element message corresponding to each patent document according to text mining;
performing an association rule algorithm to analyze all the generated technical element messages, and establishing a plurality of association rules according to an analysis result, wherein each association rule includes at least two of the technical element messages and an association rule strength; and
selecting the association rule with a weak association rule strength, and combining the at least two of the technical element messages of the association rule with the weak association rule strength to output a patentable R&D suggestion; and selecting the association rule with a strong association rule strength, and combining the at least two of the technical element messages of the association rule with the strong association rule strength to output a patent invalidation inference suggestion.

10. The R&D auxiliary method according to claim 9, wherein the R&D auxiliary method further comprises the step of: sorting and storing the loaded patent documents according to at least one patent classification number of each patent document loaded to form a technical element library.
